(19) United States
(12) Patent Application Publication
(10) Pub. No.: US 2007/0152389 A1
(43) Pub. Date: Jul. 5, 2007

(54) Metal retrofit kit for a loading dock bumper

(76) Inventors: Hans Joseph Kloppenburg, Carl-Zeiss Strass (DE); Norbert Hahn, Franklin, WI (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/321,675

(22) Filed: Dec. 29, 2005

(51) Int. Cl. F16M 1/00

(52) U.S. Cl. 267/139

(57) ABSTRACT

A retrofit kit includes brackets and a readily replaceable impactable cover plate for protecting a conventional polymeric bumper at a loading dock. In some cases, the retrofit kit includes an adjustment feature that allows the impactable cover plate to fit bumpers of various projections, wherein a bumper's projection is the distance that the bumper protrudes away from the wall or other surface to which the bumper is attached. The impactable plate can be installed to protect various types of conventional bumpers such as unitary molded bumpers or those that comprise a stack of rubber pads. The impactable plate is designed to be more durable and easier to replace than the original bumper itself. The kit and method can be used for retrofitting bumpers made of rubber, plastic or other polymers.

### FIELD OF THE DISCLOSURE

The present disclosure generally pertains to loading dock bumpers, and more specifically to an apparatus or method of retrofitting a conventional dock bumper with a replaceable, protective metal faceplate.

### DESCRIPTION OF RELATED ART

A typical loading dock of a building includes an exterior doorway with an elevated platform for loading and unloading vehicles, such as trucks and trailers. In some cases, a loading dock may include a dock leveler to compensate for a height difference that may exist between the loading dock platform and an adjacent bed of a truck or trailer. Dock levelers typically include a deck whose front edge can be raised or lowered to the approximate height of the truck bed. An extension plate or lip may extend outward from the deck's front edge to span the gap between the rear of the truck bed and the front edge of the deck, thereby providing a path that allows personnel and material handling equipment to readily move on and off the truck bed during loading and unloading operations.

Dock bumpers are often installed near the doorway for several reasons. They can protect the face the building from vehicle impact; they can protect the rear end of the truck from damage; they can prevent a dock seal from being over compressed by a vehicle backing into the dock, and/or in cases where the dock includes a dock leveler, they can establish a predetermined minimum distance between the rear of the vehicle and the dock leveler so that the dock leveler has clearance to operate. Bumpers are typically made of a molded polymer such as rubber or a stack of rubber pads stamped out of old tires, conveyor belt material, or the like. The stack of rubber pads can be clamped between two steel plates. The plates hold the pads together and provide a way for installing the bumper to the loading dock. Bumpers are usually installed near the bottom of the doorway, adjacent either side of the dock leveler lip (if a leveler is present) and protrude a few inches out from the face of the dock where they can be abutted by the rear of the vehicle.

Dock bumpers not only have to absorb the impact of trucks backing into the dock, but they must also endure tremendous vertical friction caused by weight being added and removed from the truck bed as the truck is being loaded or unloaded at the dock. Whenever a forklift, for instance, drives onto or off the truck bed, the truck's suspension allows the bed to rise and fall accordingly. The resulting friction between the face of the bumper and the back of the truck can quickly wear out the bumper.

Replacing a worn bumper can be surprisingly difficult and time consuming. Corroded anchor bolts and mounting plates that have been welded in place and may need to be cut off.

To prolong the life of bumpers and thus reduce their frequency of replacement, some bumpers have their impact absorbing material encased within a telescoping steel housing. The exterior steel plates of such a housing not only provide more wear resistance, but the steel plates also reduce the sliding friction between the bumper and the truck, as the coefficient of friction of metal-to-metal is generally much lower than that of rubber-to-metal. Steel encased bumpers, unfortunately, are very heavy, which makes them even more difficult to replace than rubber ones. Often a hoist of some sort is needed to assist in replacing a steel encased bumper. In addition; there is typically metal-to metal contact between the steel face of such bumpers and the housing—inhibiting their range of full movement.

Consequently, a need exists for a dock bumper that is more durable than conventional rubber bumpers yet is easier to service or replace than today's steel encased bumpers.

### SUMMARY OF THE DISCLOSURE

In some embodiments, conventional dock bumpers of various sizes are protected by a readily replaceable impactable metal plate.

In some embodiments, a retrofit kit for metal plating existing bumpers includes an adjustment feature for fitting bumpers of various sizes.

In some embodiments, the adjustment feature allows an impactable cover plate to be adjustably tightened against the face of a conventional bumper.

In some embodiments, the retrofit kit adapts to bumpers of various vertical lengths.

In some embodiments, the adjustment feature adapts to the bumper's projection or distance that the bumper protrudes away from the face of the wall or surface to which the bumper is mounted.

In some embodiments, separate brackets mounted independently of an existing bumper can be used for installing an add-on cover plate without having to first temporarily remove or otherwise disturb the bumper.

In some embodiments, the brackets are mounted above and below the existing bumper to make the impactable cover plate easy to install.

In some embodiments, the impactable cover plate can be selectively installed or removed without destroying the bumper's functionality.

### BRIEF DESCRIPTION OF THE DRAWINGS

FIG. 1 is a perspective view of a loading dock with two existing bumpers of which one is retrofitted with an impactable plate.

FIG. 2 is a side view of a retrofitted bumper.

FIG. 3 is a side view of a retrofitted bumper compressed by a vehicle.

FIG. 4 is a side view showing an existing bumper being retrofitted.

FIG. 5 is another side view showing an existing bumper being retrofitted.

FIG. 6 is side view showing a retrofitted bumper being adjusted.

FIG. 7 is a side view similar to FIG. 3 only smaller.

FIG. 8 is a side view of another embodiment of a retrofitted bumper.

FIG. 9 is a side view of another embodiment of a retrofitted bumper compressed by a vehicle.

FIG. 10 is a top view of FIG. 9.

FIG. 11 illustrates a first step of installing a bumper.

FIGS. 12 and 13 illustrate a second step of converting the bumper installed in FIG. 11.

FIG. 14 illustrates a third step of replacing a worn impactable plate.

### DESCRIPTION

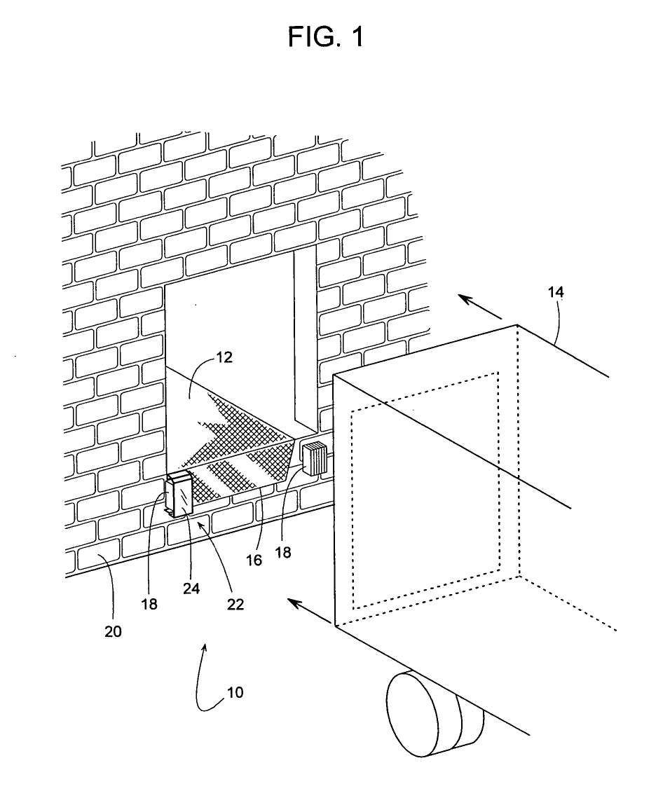

FIG. 1 shows a typical loading dock 10 with a dock leveler 12. To absorb the impact from a vehicle 14 backing into the dock, to ensure adequate operating clearance between a lip 16 of dock leveler 12 and the back of vehicle 14, and/or to protect a dock seal (not shown) from being over compressed by the back end of vehicle 14, one or more conventional dock bumpers 18 are attached either to a dock wall 20, dock leveler 12, or some other suitable mounting surface.

The bumper at the right of dock leveler 12 is shown in its originally installed condition without any protective impactable plate, and the bumper at the left side of dock leveler 12 is shown after a bumper retrofit kit 22 has been installed. Kit 22 includes a metal impactable plate 24 that is adapted to overlay the front face of pre-existing, conventional bumpers of various sizes. It should be noted that prior to installing plate 24, bumper 18 as originally installed is a fully functional bumper in itself. Nonetheless, plate 24 helps protect the bumper's front face from wear and provides a reasonably lightweight member that can be readily replaced when necessary. To show a comparison of bumpers with and without the retrofit, only the bumper on the left has impactable plate 24 installed; however, normally both bumpers would be retrofitted in a similar manner.

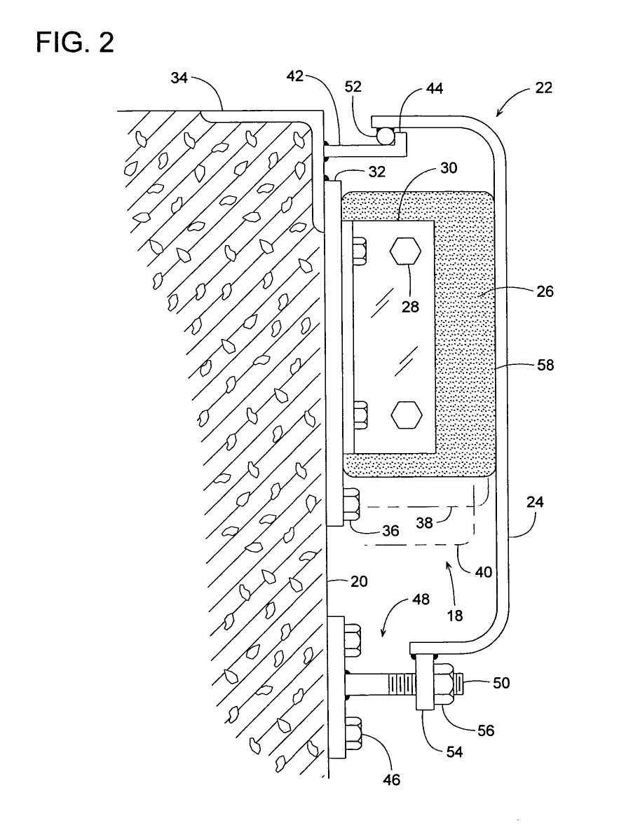

Referring to FIGS. 2 and 3, the pre-existing bumper 18 (also referred to herein as a “functional bumper”) may comprise a stack of rubber or other polymer pieces 26 together forming a compressible pad that two fasteners 28 clamp between two angle irons 30, which in turn are fastened to a mounting plate 32 to form a bumper mounting system. Mounting plate 32 may be attached to dock wall 20 in some appropriate manner. An upper edge of mounting plate 32, for example, might be welded to a metal reinforced corner 34 of dock wall 20, and a lower end of plate 32 may be held in place by way of a conventional concrete anchor 36. In other cases, the pre-existing bumper may be a unitary compressible pad molded of rubber, plastic or some other type of polymer. In this context, “compressible” indicates that the pad will be compressed by the backing vehicle as it transmits the force of that vehicle to the dock wall, and then return to a relaxed shape when the force is removed. While all materials have some degree of compressibility, the compressible pad of the embodiments herein is intended to compress substantially more than the relatively rigid/incompressible metal faceplate that overlays the compressible pad according to an inventive concept herein. Phantom lines 38 and 40 representing a plurality of bumpers of various sizes illustrate how kit 22 is capable of fitting other bumpers of indeterminate size, wherein the size is with reference to the bumper's projection and/or vertical length. Although the invention will be described with reference to a bumper comprising a stack of rubber pads, kit 22 is readily applied to molded bumpers as well.

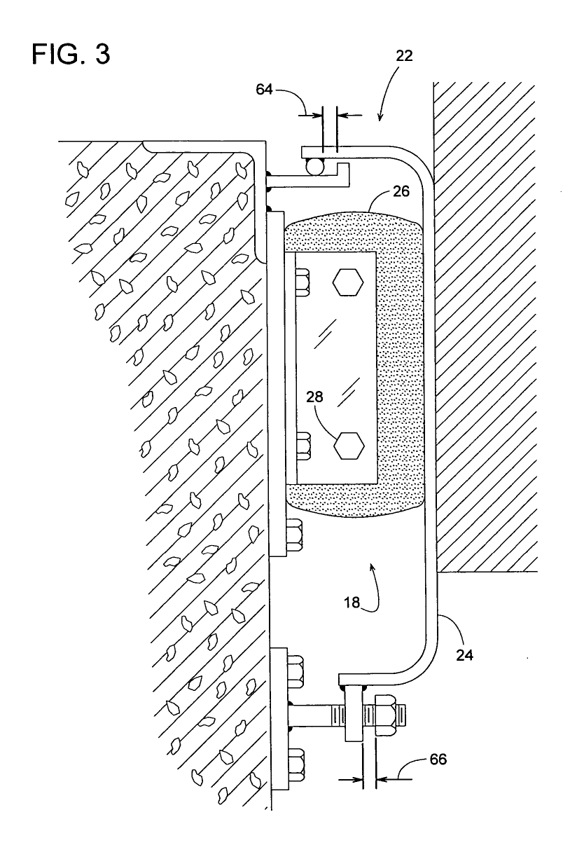

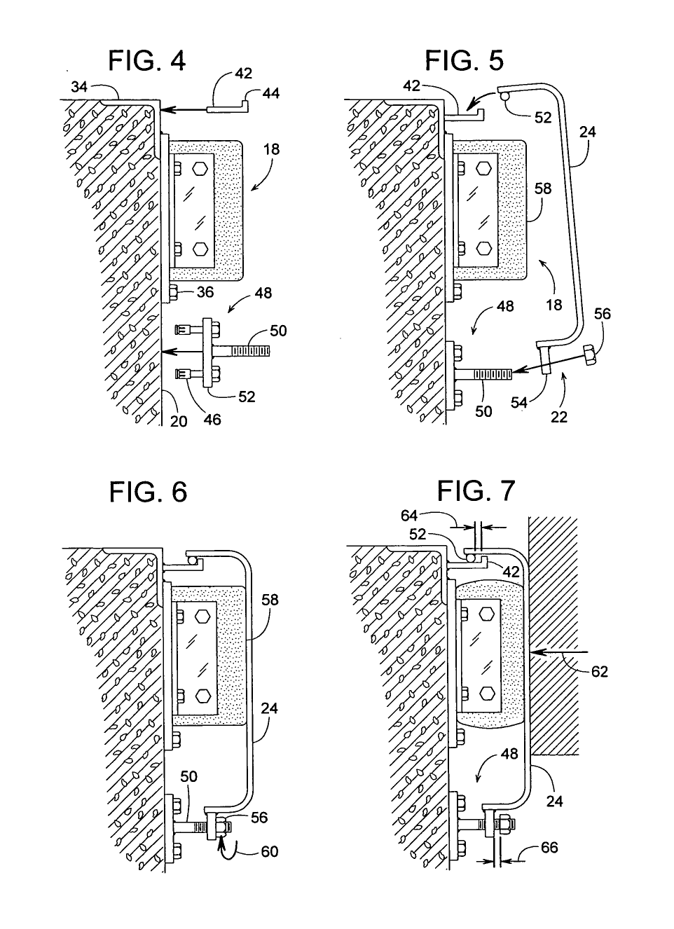

The actual design of retrofit kit 22 may vary widely; however, its basic concept is embodied in the example shown in FIGS. 2 and 3. FIGS. 4-6 show how retrofit kit 12 is installed, and FIG. 7 shows a retrofitted bumper in use.

Referring to FIG. 4, to apply the retrofit kit, a first bracket 42 with an upwardly protruding lip 44 can be mounted to dock 10 adjacent to bumper 18 but not necessarily touching the bumper. Bracket 42, for example, could be welded to the top or front face of corner 34. The bracket's length or distance it extends from corner 34 may first need to be trimmed to a length that is appropriate for the projection of bumper 18. Concrete anchors 46 can be used for mounting a second bracket 48 to dock wall 20. Again, the actual construction of brackets 42 and 48 may vary; however, in this example bracket 48 comprises a threaded fastener 50 extending from an anchor plate 52.

Next, referring to FIG. 5, impactable plate 24 can be hung from upper bracket 42 with a rod 52 or some other catch member of plate 24 resting upon bracket 42. A lower end 54 of plate 24 can be held in place by a nut 56 that screws onto fastener 50 of lower bracket 48. Once installed, rod 52 abutting lip 44 and nut 56 engaging lower end 54 limit the extent to which plate 24 can move forward (i.e., away from wall 20).

Referring to FIG. 6 (similar to FIG. 2 but smaller), nut 56 and fastener 50 provides an adjustment feature or a way of adjustably tightening plate 24 snuggly up against a front face 58 of bumper 18. Arrow 60 represents the step of adjustably tightening plate 24.

Referring to FIG. 7 (similar to FIG. 3 but smaller), in response to impact pressure 62 from vehicle 14, plate 24 moves back relative to brackets 42 and 48, as bumper 18 is compressed. As plate 24 moves back, rod 52 slides along upper bracket 42, creating a gap 64, and lower end 54 of plate 24 slides along the length of fastener 50, creating a gap 66. When the forward movement of vehicle 14 removes pressure 62, the resilience of bumper 18 pushes plate 24 back to its position of FIGS. 2 and 6.

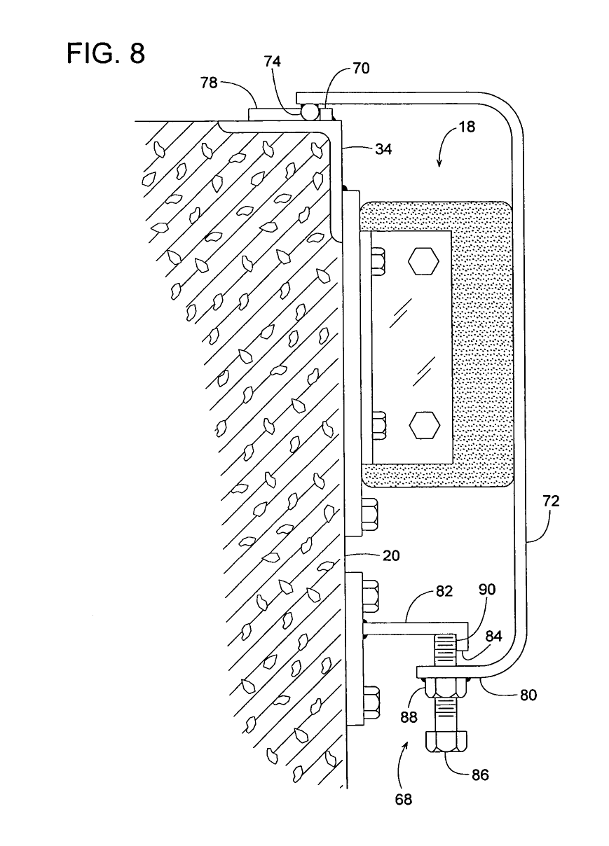

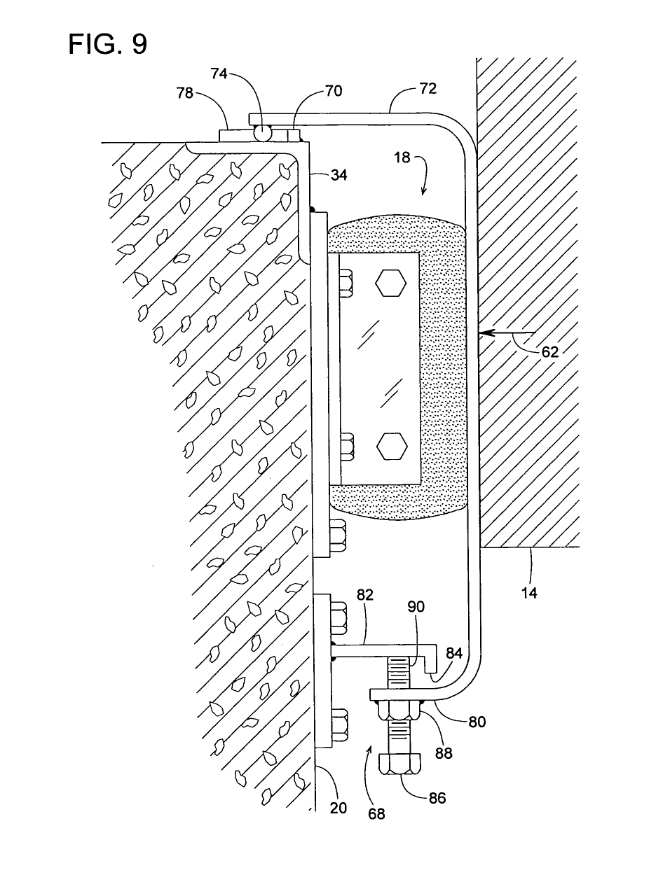

FIGS. 8, 9 and 10 show another embodiment of a retrofit kit 68. FIGS. 8 and 9 correspond to FIGS. 2 and 3 respectively, and FIG. 10 is a top view of FIG. 9. Instead of lip 44 of bracket 42, in this example, an upper bracket 70 comprises a key welded atop corner 34. Instead of rod 52 of plate 24, an impactable plate 72 includes a two-piece rod assembly 74 or some other type of catch member attached to the underside of plate 72. Referring to FIG. 10, rod assembly 74 defines a notch 76 that fits a guide key 78 attached to corner 34. Key 78 captured within the two-piece rod assembly 74 prevents plate 72 from sliding sideways off of bumper 18, yet the sliding fit between key 78 and notch 76 permits relative sliding motion between plate 72 and bracket 70 in a direction perpendicular to dock wall 20 so that plate 72 can move toward wall 20 when forced to do so under impact pressure from vehicle 14. The position of bracket 70 on corner 34 relative to the position of rod assembly 74 on plate 72 determines how tightly the upper end of plate 72 is held against the front face of bumper 18 when not under pressure from vehicle 14.

To fasten a lower end 80 of plate 72, kit 68 includes a second bracket 82 that can be mounted in a suitable manner to dock wall 20. Bracket 82 has a lip 84 that can engage a threaded fastener 86 screwed into a nut 88 welded to plate 72. A side edge 90 of fastener 86 engaging lip 84 limits the distance that lower end 80 of plate 72 can move away from wall 20. Fastener 86 also provides an adjustment feature and way to readily install and remove plate 72. Under impact pressure from vehicle 14, sliding motion between fastener 86 and lower bracket 82 allows plate 72 to move with the compression of bumper 18, as shown in FIG. 9.

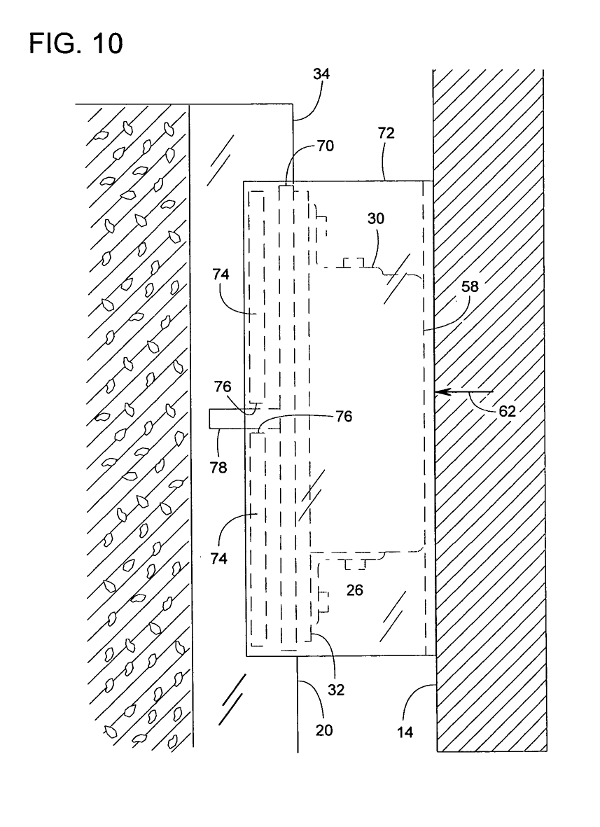

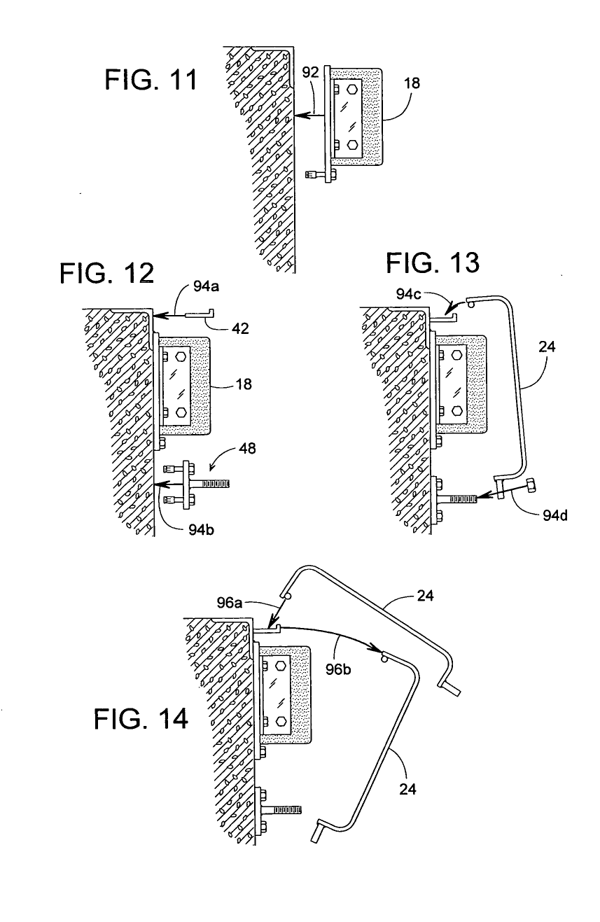

Arrow 92 of FIG. 11 represents the first step of installing bumper 18 to a loading dock; arrows 94a, 94b, 94c and 94d represent the second step of converting bumper 18 so that the bumper can be protected by a readily replaceable impactable plate 24; and arrows 96a and 96b of FIG. 14 illustrate the third step of replacing impactable plate 24 with another plate 24. The first step (arrow 92) is generally the most time consuming, as it may involve drilling in concrete, welding and other heavy operations. Next, the second step of converting the bumper would be less time consuming than the first. Once the bumper is converted, the third step can be performed in less time than the previous two steps.

Although the invention is described with respect to multiple embodiments, modifications thereto will be apparent to those skilled in the art. The impactable plate, for example, could be made of steel, stainless steel, or a material other than metal that is intended to be relatively rigid/incompressible as compared to the compressible pad/conventional bumper of the embodiments herein. Also, various features of the multiple embodiments are interchangeable. Items 70, 74 and 78 of FIG. 8, for instance, can be readily incorporated in the embodiment of FIGS. 2-7. Therefore, the scope of the invention is to be determined by reference to the following claims.

We claim:

1. A bumper retrofit kit for protecting a functional bumper of an indeterminate size, wherein the functional bumper is attached to a loading dock and includes a front face that may be subject to an impact from a vehicle; the bumper retrofit kit comprising:
a first bracket and a second bracket that are adapted for installation adjacent to the functional bumper such that the functional bumper becomes situated between the first bracket and the second bracket;
an impactable plate removably connected to the first bracket and the second bracket such that the impactable plate upon impact from the vehicle can be forcibly moved relative to the first bracket and the second bracket and the impactable plate overlays the front face of the functional bumper when the first bracket and the second bracket are installed adjacent to the functional bumper; and
an adjustment feature coupled to at least one of the first bracket, the second bracket, and the impactable plate, wherein the adjustment feature renders the bumper retrofit kit suitable for the indeterminate size.

2. The bumper retrofit kit of claim 1, wherein the first bracket and the second bracket are spaced apart from each other.

3. The bumper retrofit kit of claim 1, wherein the first bracket and the second bracket are spaced apart from the functional bumper.

4. The bumper retrofit kit of claim 1, wherein the first bracket, when installed, is above the functional bumper, and the second bracket, when installed, is below the functional bumper.

5. The bumper retrofit kit of claim 1, wherein the functional bumper remains functional even if the impactable plate was removed.

6. The bumper retrofit kit of claim 1, wherein the adjustment feature includes a threaded fastener.

7. The bumper retrofit kit of claim 6, wherein the threaded fastener helps couple the impactable plate to the second bracket and helps guide the movement of the impactable plate in a direction substantially parallel to the length of the threaded fastener as the impactable plate moves in response to vehicle impact.

8. The bumper retrofit kit of claim 1, wherein the adjustment feature forces the impactable plate tightly up against the front face of the functional bumper.

9. The bumper retrofit kit of claim 1, wherein the indeterminate size of the functional bumper pertains to a projection distance that the functional bumper extends in a direction perpendicular to the front face, and the adjustment feature adjusts the bumper retrofit kit with respect to the projection distance.

10. A bumper for absorbing an impact from a vehicle at a loading dock, the bumper comprising:
a compressible pad for compressing in response to impact from the vehicle;
a bumper mounting system that attaches the compressible pad to the loading dock;
a first bracket attached to the loading dock adjacent to the bumper mounting system but not necessarily touching the bumper mounting system;
a second bracket spaced apart from the first bracket and being attached to the loading dock adjacent to the bumper mounting system but not necessarily touching the bumper mounting system, wherein at least one of the first bracket and the second bracket is spaced apart and separate from the bumper mounting system; and
an impactable plate overlaying the compressible pad and being removably connected to the first bracket and the second bracket such that the impactable plate upon impact from the vehicle can be forcibly moved relative to the first bracket and the second bracket.

11. The bumper of claim 10, wherein the first bracket and the second bracket are spaced apart from the existing bumper.

12. The bumper of claim 10, wherein the first bracket and the second bracket are respectively above and below the existing bumper.

13. The bumper of claim 10, further comprising an adjustment feature that provides an adjustable fit between the impactable plate and the compressible pad.

14. The bumper of claim 13, wherein the adjustment feature forces the impactable plate tightly up against the compressible pad.

15. The bumper of claim 10, further comprising a threaded fastener that helps couple the impactable plate to the first bracket and helps guide the movement of the impactable plate in a direction generally parallel to the length of the threaded fastener as the impactable plate moves in response to vehicle impact.

16. A method of retrofitting a functional bumper that is attached to a loading dock, wherein the functional bumper includes a front face that may be subject to an impact from a vehicle, the method comprising:
mounting a first bracket to the loading dock adjacent to the functional bumper but not necessarily touching the functional bumper;
connecting an impactable plate to the first bracket;
adjustably tightening the impactable plate snuggly up against the front face of the functional bumper; and
allowing the impact of the vehicle to move the impactable plate relative to the first bracket.

17. The method of claim 16, further comprising:
mounting a second bracket spaced apart from the first bracket and adjacent to the functional bumper but not necessarily touching the functional bumper; and
connecting the impactable plate to the second bracket such that the impactable plate extends between the first bracket and the second bracket with the functional bumper interposed therebetween.

18. The method of claim 17, further comprising:
positioning the first bracket above the functional bumper, and
positioning the second bracket below the functional bumper.

19. The method of claim 16, wherein the first bracket is spaced apart from the functional bumper.

20. A bumper method for a loading dock, comprising:
first, installing a bumper to the loading dock;
second, converting the bumper so that the bumper can be protected by an impactable plate; and
third, replacing the impactable plate.

21. The bumper method of claim 20, wherein the step of installing the bumper is more time consuming than the step of converting the bumper, which in turn is more time consuming than the step of replacing the impactable plate.
